(19) United States
(12) Patent Application Publication
(10) Pub. No.: US 2011/0214335 A1
(43) Pub. Date: Sep. 8, 2011

(54) FISHING SINKER FOR PREVENTING LOSS THEREOF

(76) Inventor: Ki Bong SONG, Daejeon (KR)

(21) Appl. No.: 12/716,656

(22) Filed: Mar. 3, 2010

(51) Int. Cl. A01K 95/00

(52) U.S. Cl. 43/44.97; 43/43.14; 43/43.1

(57) ABSTRACT

Disclosed is a fishing sinker for preventing a loss thereof, and capable of preventing the contamination of fresh water or seawater and easily adjusting the height of the fishing sinker. The fishing sinker comprises a weight, an environment-friendly resin layer made of a biodegradable polyester and laminated on an outer surface of the weight in a predetermined thickness, and a plurality of linear protrusions formed at an outer surface of the environment-friendly resin layer.

### BACKGROUND OF THE INVENTION

1. Field of the invention

The present invention relates to a fishing sinker for preventing a loss thereof, and more particularly to a fishing sinker for preventing a loss thereof, in which an environment-friendly resin layer made of a biodegradable polyester is laminated on the outer surface of the weight in a predetermined thickness, so that it can prevent the contamination of fresh water or seawater for enjoying a fishing; a plurality of linear protrusions is formed at the outer surface of the environment-friendly resin layer in the form of a brush, so that the fishing sinker is not caught in the gaps between the stones owing to the plurality of linear protrusions although the fishing sinker is inserted into gaps between stones existing under the water, thereby easily getting out of the gaps between stones and preventing the loss of the fishing sinker; a fluorescent substance capable of emitting light under water is integrally formed at the upper end portion of the linear protrusion, so that the eye of the fish can be turned upon the fluorescent substance, so that the haul of fish can be greatly increased; and a plurality of weight materials are selectively inserted into or removed from a space of a height adjustor through a simple operation, thereby easily adjusting the height of the fishing sinker.

2. Description of the Prior Art

Generally, a fishing sinker used in sea fishing or freshwater fishing includes a relative heavy weight such as lead or brass etc. in such a manner that it is thrown at the surface of the water together with a fishhook connected to a fishing line and the fishhook faces the bottom of the surface of the water, in which the fishes exist, so as to hook the fish.

However, since the fishing sinker is made of a heavy metal such as lead or brass etc., there is a big defect in that it can contaminate fresh water or seawater for enjoying fishing.

Especially, after the above fishing sinker is thrown at the surface of the water for hooking the fish, and it sinks to the bottom of the water, it can be easily inserted into the gaps between stones during the fishing. Also, when the fishing line is lifted up, since the fishing sinker inserted into the gaps between stones is separated from the fishing lines, the loss of the fishing sinker occurs often. Accordingly, the fishing area can be more and more contaminated owing to the lost fishing sinker.

Moreover, in case of adjusting the height of the conventional fishing sinker, since the conventional fishing sinker is made of a heavy metal such as lead etc., the user can adjust the height of the fishing sinker by directly removing a part of the lead, using a separate tool. However, there are problems in that this adjustment of the height of the conventional fishing sinker is inconvenient and difficult.

Recently, in order to overcome the above problems, it is disclosed in Korean Utility Model No. 20-0273694 that an iron ore powder is injected into an elastic rubber cap and they are compressed and molded to constitute an elastic fishing sinker, thereby preventing the environment pollution of the fishing area and allowing the fishing sinker inserted into the gaps between stones to be easily escaped from the gaps.

That is, as shown in FIG. 1, the iron ore powder 3 is injected into the elastic rubber cap 2 and they are compressed and molded to constitute the elastic fishing sinker 1, so that the elastic fishing sinker 1 can prevent the environment pollution of the fishing area.

However, in case of the conventional elastic fishing sinker 1, since the separate iron ore powder 3 is injected into the elastic rubber cap 2, which is relatively thick, the separate iron ore powder 3 can be easily lost through a hole H, which is formed at the upper and lower portions of the rubber cap 2.

Moreover, in a case where the fishing sinker is inserted into the gaps between stones, since the fishing line is made stretched in a moment, it cannot easily escape from the gaps even though it is made of rubber material. Accordingly, the loss of the fishing sinker occurs often. Also, since the lost rubber cap is not easily dissolved and remains under the water, the fishing area can be more and more contaminated. Moreover, in the conventional elastic fishing sinker 1, there is a problem in that the height of the fishing sinker cannot be easily adjusted.

### SUMMARY OF THE INVENTION

Accordingly, the present invention has been made to solve the above-mentioned problems occurring in the prior art, and an object of the present invention is to provide a fishing sinker for preventing a loss thereof, in which an environment-friendly resin layer made of a biodegradable polyester is laminated on the outer surface of the weight in a predetermined thickness, so that it can prevent the contamination of fresh water or seawater for enjoying a fishing; a plurality of linear protrusions is formed at the outer surface of the environment-friendly resin layer in the form of a brush, so that the fishing sinker is not caught in the gaps between the stones owing to the plurality of linear protrusions, although the fishing sinker is inserted into gaps between stones existing under the water, thereby easily getting out of the gaps between stones and preventing the loss of the fishing sinker; a fluorescent substance capable of emitting light under water is integrally formed at the upper end portion of the linear protrusion, so that the eye of the fish can be turned upon the fluorescent substance, so that the haul of fish can be greatly increased; and a plurality of weight materials are selectively inserted into or removed from a space of a height adjustor through a simple operation, thereby easily adjusting the height of the fishing sinker.

In order to accomplish the above object, according to the present invention, there is provided a fishing sinker for preventing a loss thereof, comprising: a weight; an environment-friendly resin layer made of a biodegradable polyester and laminated on an outer surface of the weight in a predetermined thickness; and a plurality of linear protrusions formed at an outer surface of the environment-friendly resin layer.

According to the preferred embodiment of the present invention, the plurality of linear protrusions comprises a latching portion formed at a lower end portion thereof and fixed to the environment-friendly resin layer in order that it does not fall out of the environment-friendly resin layer.

According to the preferred embodiment of the present invention, the plurality of linear protrusions further comprises a fluorescent substance integrally formed at an upper end portion thereof for attracting the eye of the fish.

In order to accomplish the above object, according to the present invention, there is provided a fishing sinker for preventing a loss thereof comprising: a weight; an environment-friendly resin layer made of a biodegradable polyester and laminated on an outer surface of the weight in a predetermined thickness; a plurality of linear protrusions formed at an outer surface of the environment-friendly resin layer lengthwise; and a height adjustor having a space formed inside the weight along a vertical throughhole of the weight; wherein a female screw is formed at the inside of the lower portion of the height adjustor and a male screw, which is formed at an upper portion of a lower ring, is screw-coupled to the female screw while a latching protrusion and a packing are interposed between the lower end portion of the female screw and the lower ring.

According to the preferred embodiment of the present invention, a weight material for adjusting the height of the fishing sinker is selectively inserted into the space of the height adjustor.

According to the preferred embodiment of the present invention, the weight is made of an iron ore or a native rock.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating a conventional fishing sinker;

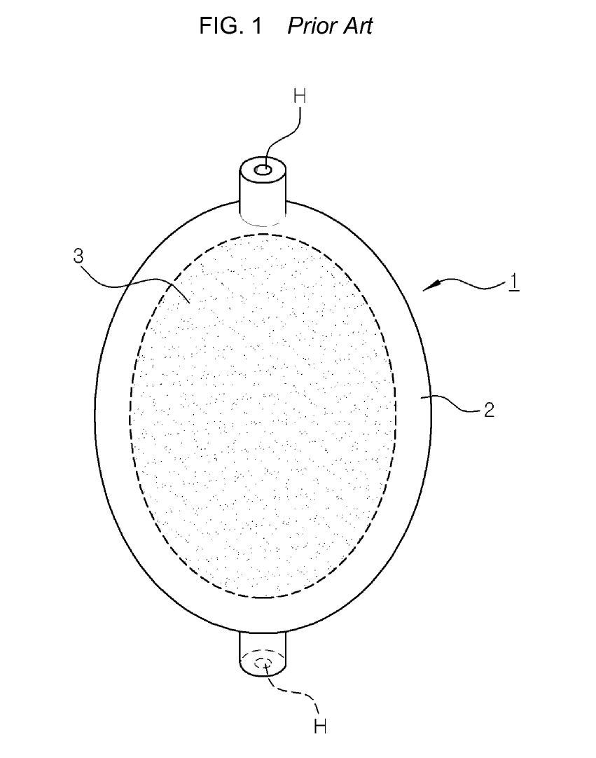

FIG. 2 is a sectional view illustrating a fishing sinker for preventing a loss thereof according to the present invention;

FIG. 3 is a partially enlarged sectional view illustrating a fishing sinker for preventing a loss thereof according to the present invention;

FIG. 4 is a sectional view illustrating a fishing sinker for preventing a loss thereof according to another embodiment of the present invention;

FIG. 5 is a sectional view illustrating a fishing sinker for preventing a loss thereof having a height adjustor formed inside a weight according to the present invention; and

FIG. 6 is an exploded sectional view illustrating the fishing sinker of FIG. 5.

### DETAILED DESCRIPTION OF THE PREFERRED EMBODIMENTS

Hereinafter, exemplary embodiments of the present invention will be described with reference to accompanying drawings.

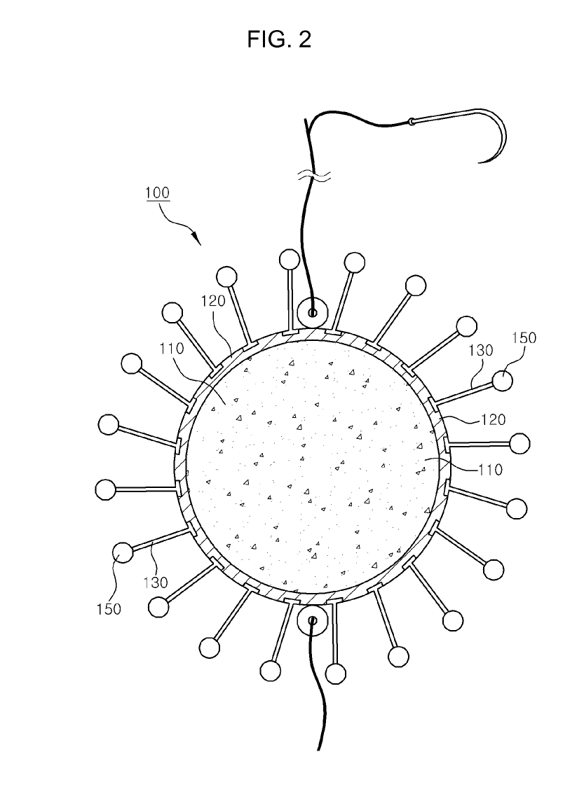

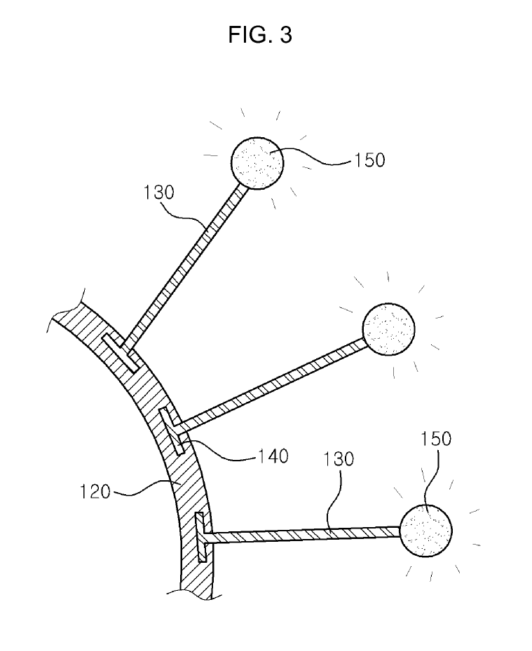

FIG. 2 is a sectional view illustrating a fishing sinker for preventing a loss thereof according to the present invention. FIG. 3 is a partially enlarged sectional view illustrating a fishing sinker for preventing a loss thereof according to the present invention.

As shown in FIGS. 2 and 3, the fishing sinker 100 for preventing the loss thereof according to the present invention includes a weight 110 made of an iron ore or a processed natural stone, etc., an environment-friendly resin layer 120 made of a biodegradable polyester and laminated on an outer surface of the weight 100 in a predetermined thickness, and a plurality of linear protrusions 130 formed at an outer surface of the environment-friendly resin layer 120.

Here, the plurality of linear protrusions 130 formed at an outer surface of the environment-friendly resin layer 120 includes a latching portion 140 formed at a lower end portion thereof such that the protrusions are firmly fixed to the environment-friendly resin layer 120 and thus does not easily fall out of the environment-friendly resin layer 120.

Also, the plurality of linear protrusions 130 formed at an outer surface of the environment-friendly resin layer 120 includes a fluorescent substance 150 integrally formed at an upper end portion thereof for attracting the eye of the fish or drawing attention of the fish, due to light emitted from the fluorescent substance 150.

Hereinafter, the operation and effects of the fishing sinker for preventing the loss thereof according to the present invention will be described with reference to accompanying drawings.

That is, as shown in FIGS. 2 and 3, the fishing sinker 100 for preventing the loss thereof according to the present invention having the weight 110 made of an iron ore or a processed natural stone, etc. is provided with the environment-friendly resin layer 120 made of a biodegradable polyester and laminated on the outer surface of the weight 100 in a predetermined thickness, so that it can prevent the contamination of fresh water or seawater for enjoying a fishing. Especially, although the fishing sinker 100 is lost in fresh water or seawater, it can prevent the environmental pollution of the fishing area owing to the environment-friendly resin layer 120 made of a biodegradable polyester and formed on the outer surface of the weight 110 in a predetermined thickness.

Also, the fishing sinker 100 for preventing the loss thereof according to the present invention is further provided with the plurality of linear protrusions 130 formed at the outer surface of the environment-friendly resin layer 120 in the form of a brush. In this case, the latching portion 140 is formed at a lower end portion of each linear protrusion 130 formed at an outer surface of the environment-friendly resin layer 120, so that each linear protrusion 130 does not easily fall out of the environment-friendly resin layer 120, thereby strongly fixing them to the environment-friendly resin layer 120.

Accordingly, although the fishing sinker 100 for preventing the loss thereof according to the present invention is inserted into gaps between stones existing under the water, the fishing sinker 100 is not caught in the gaps between the stones owing to the plurality of linear protrusions 130 formed at the outer surface of the environment-friendly resin layer 120, so that it can easily get out of the gaps between stones, thereby preventing the loss of the fishing sinker 100.

Moreover, the plurality of linear protrusions 130 formed at an outer surface of the environment-friendly resin layer 120 is further provided with the fluorescent substance 150 integrally formed at the upper end portion thereof. The fluorescent substance 150 is capable of emitting light under water, so that the eye of the fish can be turned upon the fluorescent substance 150, i.e., attracted toward the fishing sinker, thereby the haul of fish can be greatly increased.

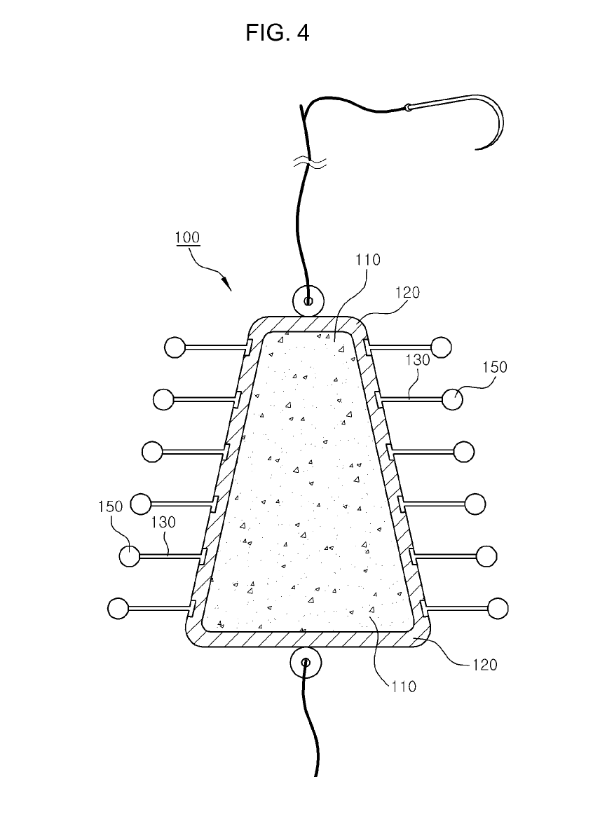

FIG. 4 is a sectional view illustrating a fishing sinker for preventing a loss thereof according to another embodiment of the present invention. The fishing sinker of FIG. 4 may have a truncated conical shape.

As shown in FIG. 4, in a state that the environment-friendly resin layer 120 made of a biodegradable polyester is laminated on the outer surface of a trapezoidal weight 110 of the trapezoidal fishing sinker 100 in a predetermined thickness, the plurality of linear protrusions 130 is formed at the outer surface of the environment-friendly resin layer 120 in the form of a brush. Here, the fluorescent substance 150 capable of emitting light under water is integrally formed at the upper end portion of each linear protrusions 130, thereby obtaining the same effects as described above.

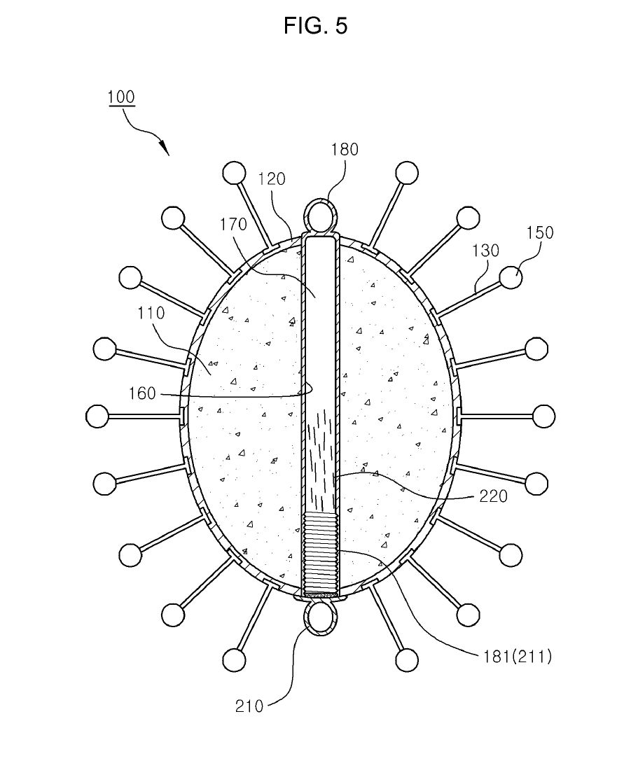

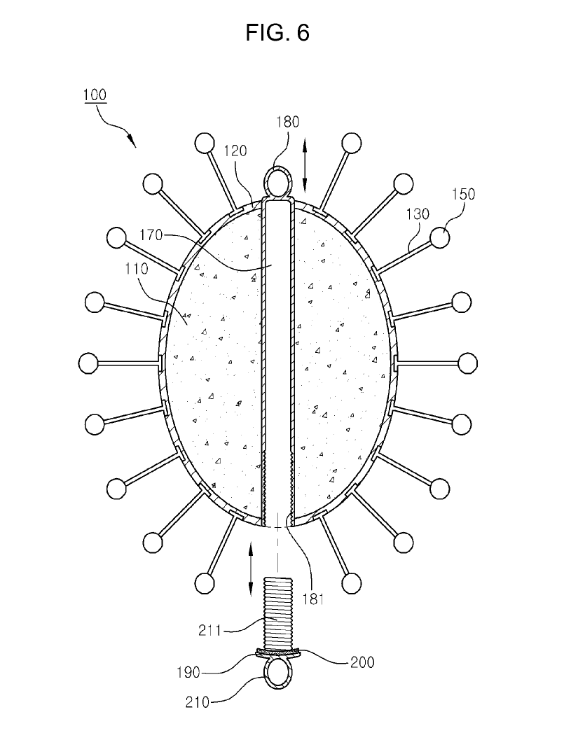

FIG. 5 is a sectional view illustrating a fishing sinker for preventing a loss thereof having a weight adjustor formed inside a weight according to the present invention and FIG. 6 is an exploded sectional view illustrating the fishing sinker of FIG. 5.

As shown in FIGS. 5 and 6, in a state that the environment-friendly resin layer 120 made of a biodegradable polyester is laminated on the outer surface of the weight 110 of the fishing sinker 100 made of an iron ore or a processed natural stone, etc. in a predetermined thickness, as described above, the plurality of linear protrusions 130 is formed at the outer surface of the environment-friendly resin layer 120 of the fishing sinker 100 and a weight adjustor 180 having a space 170 is formed inside the weight 110 along a vertical throughhole 160 of the weight 110.

Also, a female screw 181 is formed at the inside of the lower portion of the weight adjustor 180 and a male screw 211, which is formed at an upper portion of a lower ring 210, is screw-coupled to the female screw 181. A latching stopper 190 is formed between the lower ring 210 and the male screw 211, and a packing 200 are interposed between the lower end portion of the female screw 181 and the latching stopper 210, when the male screw 211 is tightened into the female screw 181.

Also, a weight material 220 for adjusting the weight of the fishing sinker 100 is selectively inserted into the space 170 of the height adjustor 180.

Accordingly, after the lower ring 210 is separated from the weight adjustor 180 formed inside the weight 110, a plurality of weight materials 220 such as a wire etc. are inserted into the space 170 of the weight adjustor 180 or a predetermined amount of the weight materials 220 are removed from the space 170 of the weight adjustor 180 and then, the male screw 211 is simply screw-coupled to the female screw 181, thereby easily adjusting the weight of the fishing sinker 100.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A fishing sinker for preventing a loss thereof comprising:
a weight;
an environment-friendly resin layer made of a biodegradable polyester and laminated on an outer surface of the weight in a predetermined thickness; and
a plurality of linear protrusions formed at an outer surface of the environment-friendly resin layer lengthwise.

2. A fishing sinker for preventing a loss thereof as claimed in claim 1, wherein the linear protrusion comprises a latching portion formed at a lower end portion thereof and fixed to the environment-friendly resin layer in order that it does not fall out of the environment-friendly resin layer.

3. A fishing sinker for preventing a loss thereof as claimed in claim 1, wherein the linear protrusion further comprises a fluorescent substance integrally formed at an upper end portion thereof for attracting the eye of fish.

4. A fishing sinker for preventing a loss thereof comprising:
a weight;
an environment-friendly resin layer made of a biodegradable polyester and laminated on an outer surface of the weight in a predetermined thickness;
a plurality of linear protrusions formed at an outer surface of the environment-friendly resin layer; and
a height adjustor having a space formed inside the weight along a vertical throughhole of the weight;
wherein a female screw is formed at the inside of the lower portion of the height adjustor and a male screw, which is formed at an upper portion of a lower ring, is screw-coupled to the female screw while a latching protrusion and a packing are interposed between the lower end portion of the female screw and the lower ring.

5. A fishing sinker for preventing a loss thereof as claimed in claim 4, wherein a weight material for adjusting the height of the fishing sinker is selectively inserted into the space of the height adjustor.

6. A fishing sinker for preventing a loss thereof as claimed in claim 4, wherein the weight is made of an iron ore or a natural stone.
